(19) United States
(12) Patent Application Publication
(10) Pub. No.: US 2013/0247558 A1
(43) Pub. Date: Sep. 26, 2013

(54) HEAT PUMP WITH TURBINE-DRIVEN ENERGY RECOVERY SYSTEM

(71) Applicant: RICHARD H. MARUYA, Kaneohe, HI (US)

(72) Inventor: RICHARD H. MARUYA, Kaneohe, HI (US)

(21) Appl. No.: 13/427,618

(22) Filed: Mar. 22, 2012

(51) Int. Cl. B60K 6/20

(52) U.S. Cl. 60/597

(57) ABSTRACT

The heat pump with a turbine-driven energy recovery system provides selectively cooled and/or heated air and recovers energy from refrigerant circulation. The heat pump includes a condenser for receiving refrigerant and condensing the refrigerant into a cooled liquid to release thermal energy therefrom. An evaporator receives the cooled liquid refrigerant and boils the refrigerant, the evaporator absorbing thermal energy to boil the refrigerant. A compressor circulates the refrigerant between the condenser and the evaporator, as is conventionally known. At least one turbine is positioned in a refrigerant flow path between the condenser and the evaporator, such that the at least one turbine is driven by the refrigerant circulating therebetween. At least one electrical generator is driven by the at least one turbine, the at least one generator being in electrical communication with the compressor for providing power thereto.

### BACKGROUND OF THE INVENTION

1. Field of the Invention

The present invention relates to heat pumps, and particularly to a heat pump with a turbine-driven energy recovery system to reduce power consumption.

2. Description of the Related Art

Heat pumps have the ability to move thermal energy from one environment to another, and in either direction. This allows the heat pump to effectively bring thermal energy into an occupied space, or to take it out. In practice, this is performed in the opposite direction of a temperature gradient. A heat pump works in the same manner as an ordinary air conditioner (A/C), which is also a type of heat pump. In the warming mode for a space, a heat pump effectively reverses a refrigeration unit so that the warm radiator is inside the space, rather than outside.

A heat pump uses an intermediate fluid, called a refrigerant, which absorbs heat as it vaporizes and releases the heat when it is condensed. It uses an evaporator to absorb heat from inside an occupied space and rejects this heat to the outside through the condenser. The refrigerant flows outside of the space to be heated or cooled, where the condenser and compressor are located, while the evaporator is inside. The key component that makes a heat pump different from an air conditioner is the reversing valve. The reversing valve allows for the flow direction of the refrigerant to be changed. This allows the heat to be pumped in either direction.

In the heating mode, the outdoor coil becomes the evaporator while the indoor coil becomes the condenser, which absorbs the heat from the refrigerant and dissipates to the air flowing through it. The air outside, even at 0° C. (or at any temperature above absolute zero), has heat energy in it. With the refrigerant flowing in the opposite direction, the evaporator (outdoor coil) is absorbing the heat from the air and moving it inside. Once it picks up heat, it is compressed and then sent to the condenser (indoor coil). The indoor coil then injects the heat into the air handler, which moves the heated air throughout the house.

In the cooling mode, the outdoor coil is now the condenser. The indoor coil is now the evaporator in the sense that it is going to be used to absorb the heat from inside the enclosed space. The evaporator absorbs the heat from the inside, and takes it to the condenser where it is rejected into the outside air.

Since the heat pump uses a certain amount of work to move the refrigerant, the amount of energy deposited on the hot side is greater than taken from the cold side. One common type of heat pump works by exploiting the physical properties of a volatile evaporating and condensing fluid. Such a volatile fluid is typically what is meant by the term “refrigerant”.

The working fluid, in its gaseous state, is pressurized and circulated through the system by a compressor. On the discharge side of the compressor, the now hot and highly pressurized vapor is cooled in a heat exchanger, called a condenser, until it condenses into a high pressure, moderate temperature liquid. The condensed refrigerant then passes through a pressure-lowering device, also called a metering device, such as an expansion valve, capillary tube, or possibly a work-extracting device, such as a turbine.

The low pressure, liquid refrigerant leaving the expansion device enters another heat exchanger, the evaporator, in which the fluid absorbs heat and boils. The refrigerant then returns to the compressor and the cycle is repeated. In such a system, it is essential that the refrigerant reaches a sufficiently high temperature when compressed, since the second law of thermodynamics prevents heat from flowing from a cold fluid to a hot heat sink. Practically, this means the refrigerant must reach a temperature greater than ambient around the high-temperature heat exchanger. Similarly, the fluid must reach a sufficiently low temperature when allowed to expand, or heat cannot flow from the cold region into the fluid; i.e., the fluid must be colder than ambient around the cold-temperature heat exchanger. In particular, the pressure difference must be great enough for the fluid to condense at the hot side and still evaporate in the lower pressure region at the cold side.

The greater the temperature difference, the greater the required pressure difference, and consequently the more energy needed to compress the fluid. Thus, as with all heat pumps, the coefficient of performance (i.e., the amount of heat moved per unit of input work required) decreases with increasing temperature difference.

When comparing the performance of heat pumps, it is best to avoid the word “efficiency”, which has a very specific thermodynamic definition. The term coefficient of performance (COP) is used to describe the ratio of useful heat movement to work input. Most vapor-compression heat pumps use electrically powered motors for their work input. However, in most vehicle applications, shaft work, via their internal combustion engines, provides the needed work. When used for heating a building on a mild day of, for example, 10° C., a typical air-source heat pump has a COP of 3 to 4, whereas a typical electric resistance heater has a COP of 1.0. In other words, one Joule of electrical energy will cause a resistance heater to produce one Joule of useful heat, while under ideal conditions, one Joule of electrical energy can cause a heat pump to move much more than one Joule of heat from a cooler place to a warmer place.

In order to improve the COP of a heat pump system, one ordinarily needs to reduce the temperature gap at which the system works. For a heating system, this would mean two things: First, one must reduce output temperature to around 30° C., which requires piped floor, wall or ceiling heating, or oversized water to air heaters. Second, one must also increase input temperature (typically by using an oversized ground source). For an air cooler, COP could be improved by using ground water as an input instead of air, and by reducing temperature drop on the output side through increasing air flow. For both systems, also increasing the size of pipes and air canals would help to reduce noise and the energy consumption of pumps (and ventilators).

Additionally, in order to improve COP, the heat pump unit itself may be modified by doubling the size of the internal heat exchangers relative to the power of the compressor, thus reducing the system's internal temperature gap over the compressor. This last measure, however, makes such heat pumps unsuitable to produce output above roughly 40° C., which means that a separate machine is needed for producing hot tap water.

It would be desirable to decrease the energy consumption of a heat pump with no reduction in the output of hot or cold air without making such modifications to the heat pump itself or to the surrounding ventilation or other structure. Thus, a heat pump with a turbine-driven energy recovery system solving the aforementioned problems is desired.

### SUMMARY OF THE INVENTION

The heat pump with a turbine-driven energy recovery system is a heat pump for providing selectively cooled and/or heated air. The system recovers energy from refrigerant circulation. The heat pump with a turbine-driven energy recovery system includes a condenser for receiving refrigerant and condensing the refrigerant into a cooled liquid to release thermal energy therefrom. A first fan is provided for selectively blowing ambient air about the condenser to selectively produce heated air with the released thermal energy. An evaporator receives the cooled liquid refrigerant and boils the refrigerant, the evaporator absorbing thermal energy to boil the refrigerant. A second fan selectively blows ambient air about the evaporator to selectively produce cooled air due to the absorbed thermal energy.

A compressor circulates the refrigerant between the condenser and the evaporator, as is conventionally known. At least one turbine is positioned in a refrigerant flow path between the condenser and the evaporator, such that the at least one turbine is driven by the refrigerant circulating therebetween. At least one electrical generator is driven by the at least one turbine, the at least one generator being in electrical communication with the compressor for providing power thereto.

These and other features of the present invention will become readily apparent upon further review of the following specification and drawings.

### BRIEF DESCRIPTION OF THE DRAWINGS

FIG. 1 is a schematic diagram of a heat pump with a turbine-driven energy recovery system according to the present invention.

FIG. 2 is a diagrammatic side view of a turbine unit and generator of the heat pump with a turbine-driven energy recovery system of FIG. 1.

Similar reference characters denote corresponding features consistently throughout the attached drawings.

### DETAILED DESCRIPTION OF THE PREFERRED EMBODIMENTS

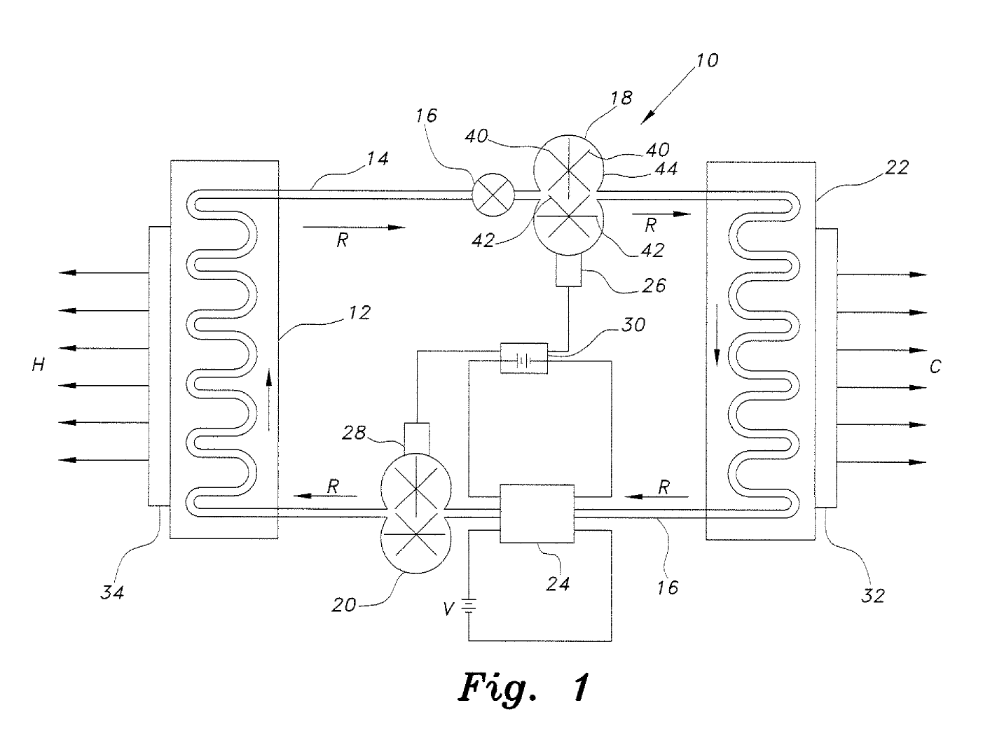

The heat pump with a turbine-driven energy recovery system 10 is a heat pump for providing selectively cooled and/or heated air. The heat pump and system 10 recovers energy from refrigerant circulation. As shown in FIG. 1, the heat pump 10 includes a condenser 12 for receiving refrigerant and condensing the refrigerant into a cooled liquid to release thermal energy therefrom. The condenser 12 may be any suitable type of condenser, as is well known in the field of heat pumps, heating and refrigeration. As shown by the directional arrows R in FIG. 1, the refrigerant flows through heat pump 10 in a clockwise direction (in the exemplary configuration of FIG. 1) so that the refrigerant flows through the condenser 12, starting in a heated vapor phase in the lower conduit 16 (in the exemplary configuration of FIG. 1) and being output as a cooled liquid the into upper conduit 14.

As is common in the field of heat pumps and the like, a first fan 34 is preferably provided for selectively drawing ambient air from about the condenser 12 to selectively produce a flow of heated air H from the thermal energy released by condensation of the heated, vaporized refrigerant into a cooled liquid phase. The cooled liquid refrigerant then circulates to an evaporator 22 via the upper conduit 14. The evaporator 22 receives the cooled liquid refrigerant and boils the refrigerant to produce the heated vapor stage. Ambient thermal energy is absorbed to effect the boiling and vaporization. Similar to first fan 34, a second fan 32 is also preferably provided for selectively drawing the ambient air from about the evaporator 22 to selectively produce a flow of cooled air C due to the thermal energy absorbed by the evaporator coil. The evaporator 22 may be any suitable type of evaporator, as is well known in the field of heat pumps, heating and refrigeration.

A compressor 24, powered by an external power source V, circulates the refrigerant between the condenser 12 and the evaporator 22, as is conventionally known. The compressor 24 may be any suitable type of condenser, as is well known in the field of heat pumps, heating and refrigeration. At least one turbine is positioned in the refrigerant flow paths between the condenser 12 and the evaporator 22. In FIG. 1, a pair of twin turbine units 18, 20 are shown. It should be understood that any desired number of turbine units may be placed in the refrigerant flow paths between the condenser 12 and the evaporator 22. Similarly, conventional turbines may be used, as well as the twin turbine units shown in FIG. 1. Each turbine is driven by the refrigerant flow.

Each turbine unit 18, 20 drives a respective electrical generator 26, 28, and each generator is in electrical communication with the compressor 24 for providing power thereto, As shown, an electrical storage battery 30 is preferably connected to each generator 26, 28 and to the compressor 24. In such an arrangement, the generators 26, 28 charge the storage battery 30, which may be used either as a source of emergency power or to replace the external power source V when fully charged, thus allowing recovered energy to be used to power the compressor 24.

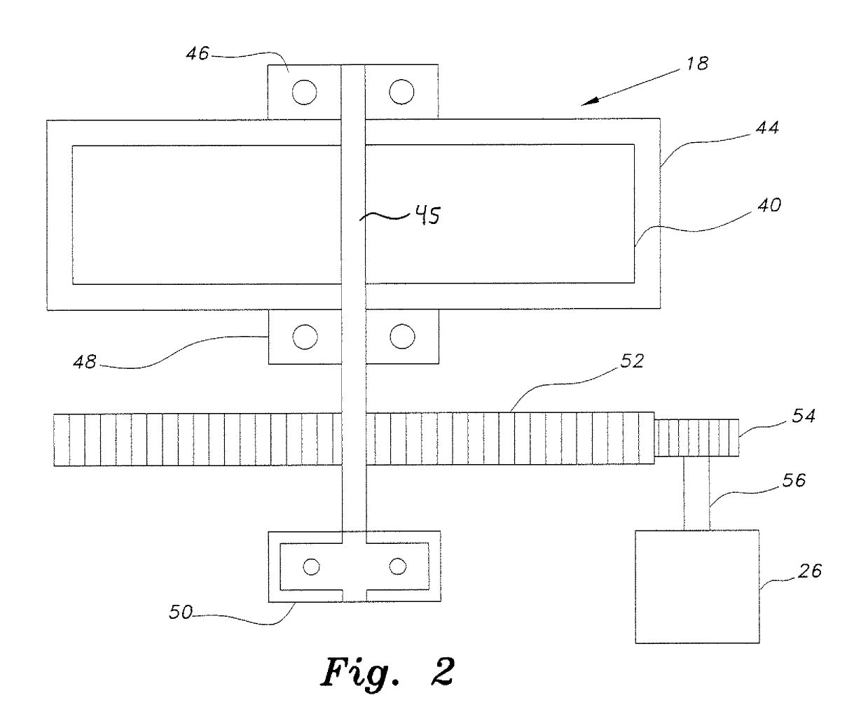

As noted above, and as shown in FIG. 1, each turbine unit 18, 20 may be a twin turbine unit having first and second turbines mounted within a sealed housing 44. The blades 40 of the first turbine and the blades 42 of the second turbine intermesh in a central region of the sealed housing 44, and the refrigerant flow path passes through the central region. FIG. 2 illustrates an exemplary arrangement for the turbine unit 18. It should be understood that the second turbine unit 20 operates in a similar manner. Turbine blades 40 are mounted to a shaft 45, the turbine blades 40 (and, similarly, blades 42 mounted on a similar shaft in the twin turbine configuration) rotating within a sealed housing 44. Upper and lower bearings 46, 48 may be provided to effect free rotation of the shaft 45 with minimal frictional resistance. A gear 52 is mounted on the shaft 45 such that rotation of shaft 45 drives rotation of the gear 52. The gear 52 may be mounted between the lower bearing 48 and a base bearing 50, as shown. The gear 52 engages a gear 54 mounted on a drive shaft 56 of the generator 26 for driving the generator 26 to produce electrical energy.

As shown in FIG. 1, a pressure lowering device, such as expansion valve 16, may also be placed in the refrigerant flow path between the condenser 12 and the evaporator 22, as is conventionally known in the field of heat pumps and the like. In use, the user may operate the heat pump 10 to produce just hot air H (by selectively actuating the first fan 12), to produce just cool air C (by selectively actuating the second fan 32), or to simultaneously produce hot air H and cool air C. The two air streams H and C may be blended by venting, ducting or the like. The user may adjust the amount of blending between the hot air H and cool air C to adjust the overall resultant temperature. The refrigerant used in the heat pump 10 may be any suitable type of refrigerant. Preferably, the refrigerant is a multi-hydrocarbon blend, such as R443A. R443A consists essentially of about 40% propane, about 55% propylene, and about 5% isobutane by volume, as described in Applicant's co-pending U.S. patent application Ser. No. 13/106,701, filed May 12, 2011, which is herein incorporated by reference in its entirety. Another similar multi-hydrocarbon blend that may be used in the heat pump 10 is R441A, as taught by U.S. Pat. No. 8,097,182 B2, which is herein incorporated by reference in its entirety. It should, however, be understood that any suitable type of refrigerant may be utilized.

It is to be understood that the present invention is not limited to the embodiments described above, but encompasses any and all embodiments within the scope of the following claims.

I claim:

1. A heat pump with a turbine-driven energy recovery system, comprising:
a refrigerant;
a condenser configured for receiving the refrigerant and condensing the refrigerant into a cooled liquid, thereby releasing thermal energy;
a first fan positioned adjacent the condenser, the first fan being configured for selectively drawing ambient air from about the condenser to selectively produce a flow of air heated by the thermal energy released by condensation of the refrigerant in the condenser;
an evaporator receiving the cooled liquid refrigerant from the condenser, the evaporator being configured for absorbing thermal energy to boil the refrigerant;
a second fan positioned adjacent the evaporator, the second fan being configured for selectively drawing ambient air from about the evaporator to selectively produce cooled air due to the thermal energy absorbed in the evaporator;
a compressor;
conduits defining flow paths between the condenser and the evaporator for circulating the refrigerant between the condenser and the evaporator;
at least one turbine positioned in at least one of the refrigerant flow paths between the condenser and the evaporator, the at least one turbine being driven by the refrigerant circulating therebetween; and
at least one electrical generator driven by the at least one turbine, the at least one generator being in electrical communication with the compressor for providing power to the compressor.

2. The heat pump as recited in claim 1, further comprising means for selectively lowering pressure of the refrigerant.

3. The heat pump as recited in claim 2, wherein said means for selectively lowering the pressure of the refrigerant comprises an expansion valve disposed in at least one of the flow paths.

4. The heat pump as recited in claim 1, further comprising an electrical storage battery in electrical communication with said at least one generator and said compressor.

5. The heat pump as recited in claim 1, wherein said at least one turbine comprises a twin turbine unit having a sealed housing and first and second turbines mounted within the sealed housing, the first and second turbines having blades intermeshing in a central region of the sealed housing, said at least one refrigerant flow path passing through the central region.

6. The heat pump as recited in claim 1, wherein the refrigerant is a multi-hydrocarbon blend.

7. The heat pump as recited in claim 6, wherein the refrigerant is R443A.

8. The heat pump as recited in claim 6, wherein the refrigerant is R441A.

9. An energy-efficient heat pump system, comprising:
a refrigerant;
a condenser configured for receiving the refrigerant and condensing the refrigerant into a cooled liquid, thereby releasing thermal energy;
a first fan positioned adjacent the condenser, the first fan being configured for selectively drawing ambient air from about the condenser to selectively produce a flow of air heated by the thermal energy released by condensation of the refrigerant in the condenser;
an evaporator receiving the cooled liquid refrigerant from the condenser, the evaporator being configured for absorbing thermal energy to boil the refrigerant;
a second fan positioned adjacent the evaporator, the second fan being configured for selectively drawing ambient air from about the evaporator to selectively produce cooled air due to the thermal energy absorbed in the evaporator;
a compressor;
conduits defining flow paths between the condenser and the evaporator for circulating the refrigerant between the condenser and the evaporator;
at least one twin turbine unit positioned in at least one of the refrigerant flow paths between the condenser and the evaporator, the at least one turbine being driven by the refrigerant circulating therebetween, the twin turbine unit having a sealed housing and first and second turbines mounted within the sealed housing, the first and second turbines having intermeshing blades in a central region of the sealed housing, the at least one refrigerant flow path passing through the central region; and
at least one electrical generator driven by the at least one twin turbine unit, the at least one generator being in electrical communication with the compressor for providing power to the compressor.

10. The energy-efficient heat pump system as recited in claim 9, further comprising means for selectively lowering pressure of the refrigerant.

11. The energy-efficient heat pump system as recited in claim 10, wherein said means for selectively lowering the pressure of the refrigerant comprises an expansion valve disposed in at least one of the refrigerant flow paths.

12. The energy-efficient heat pump system as recited in claim 9, further comprising an electrical storage battery in electrical communication with said at least one generator and said compressor.

13. The energy-efficient heat pump system as recited in claim 9, wherein the refrigerant is a multi-hydrocarbon blend.

14. The energy-efficient heat pump system as recited in claim 13, wherein the refrigerant is R443A.

15. The energy-efficient heat pump system as recited in claim 13, wherein the refrigerant is R441A.

16. An energy-efficient heat pump system, comprising:
a refrigerant;
a condenser configured for receiving the refrigerant and condensing the refrigerant into a cooled liquid, thereby releasing thermal energy;
a first fan positioned adjacent the condenser, the first fan being configured for selectively drawing ambient air from about the condenser to selectively produce a flow of air heated by the thermal energy released by condensation of the refrigerant in the condenser;
an evaporator receiving the cooled liquid refrigerant from the condenser, the evaporator being configured for absorbing thermal energy to boil the refrigerant;
a second fan positioned adjacent the evaporator, the second fan being configured for selectively drawing ambient air from about the evaporator to selectively produce cooled air due to the thermal energy absorbed in the evaporator;
a compressor;
conduits defining flow paths between the condenser and the evaporator for circulating the refrigerant between the condenser and the evaporator;
at least one turbine positioned in at least one of the refrigerant flow paths between the condenser and the evaporator, the at least one turbine being driven by the refrigerant circulating therebetween;
at least one electrical generator driven by the at least one turbine, the at least one generator being in electrical communication with the compressor for providing power to the compressor; and
an electrical storage battery in electrical communication with the at least one generator and the compressor.

17. The energy-efficient heat pump system as recited in claim 16, further comprising means for selectively lowering pressure of the refrigerant.

18. The energy-efficient heat pump system as recited in claim 17, wherein said means for selectively lowering the pressure of the refrigerant comprises an expansion valve disposed in at least one of the refrigerant flow paths.

19. The energy-efficient heat pump system as recited in claim 16, wherein said at least one turbine comprises a twin turbine unit having a sealed housing and first and second turbines mounted within the sealed housing, the first and second turbines having intermeshing blades in a central region of the sealed housing, the at least one refrigerant flow path passing through the central region.

20. The energy-efficient heat pump system as recited in claim 16, wherein the refrigerant is a multi-hydrocarbon blend selected from the group consisting of R443A and R441A.
